(19) United States
(12) Patent Application Publication
(10) Pub. No.: US 2026/0014479 A1
(43) Pub. Date: Jan. 15, 2026

(54) ITEM ENHANCEMENT SYSTEM FOR ROLE PLAYING GAME

(71) Applicant: Apocalypse Studios, Inc., Oakville (CA)

(72) Inventors: Denis Dyack, St. Catharines (CA); Yuriy Toporovskyy, Caledonia (CA); Edvard Toth, Caledonia (CA); Paul Rogozinski, London (CA)

(73) Assignee: Apocalypse Studios, Inc., Oakville (CA)

(21) Appl. No.: 19/269,254

(22) Filed: Jul. 15, 2025

Related U.S. Application Data
(60) Provisional application No. 63/671,329, filed on Jul. 15, 2024.

(51) Int. Cl. A63F 13/69; A63F 13/58

(52) U.S. Cl. CPC A63F 13/69; A63F 13/58

(57) ABSTRACT

A system for incorporating inscriptions into items based on player feats achieved by the performance of specific actions or sequences of actions by the player. An inscription is a classification of a game item, usually a transferable token such as a weapon, armor, or a valuable object, that defines certain properties of that transferable token based on the action of the player. Inscriptions may then be granted, updated, or modified according to player actions to dynamically alter the characteristics of the item according to game play so that player choices on a micro and macro level are an essential component of received items and that the knowledge that the player has of the game universe and narrative elements are incorporated into items collecting during the game.

### BACKGROUND OF THE INVENTION

### 1. Field of the Invention

The present disclosure relates to role playing games and, more specifically, to a system for enabling item enhancement.

### 2. Description of the Related Art

Typical role playing game (RPG) reward systems grant players random or semi-random rewards for completing quests or defeating enemies. This approach, however, can present several issues. For example, as a player character progresses, the player needs to find an increasingly narrower set of gear to improve their character. As a result, random rewards become increasingly frustrating and uninteresting as those items are increasingly unlikely to meet the needs of the user. In addition, the current approach causes a disconnect between player actions and rewards. The player is incentivized to defeat the hardest content at the fastest speed, without concern for the type of content or different decisions they make during that time. This leads to mindless farming and defeats any other efforts made to engage players. Finally, these factors devalue the bulk of items, and the various methods of returning value to those items (disenchantment, trading) quickly become tedious or appear to players as arbitrary rate limit. In other words, players begin to spend increasingly large amounts of time and effort on inventory management and trading items that are useful but not to them, instead of engaging in the actual core experience. As a result, there is a need for a system that can remedy these shortcomings by making player choices on a micro and macro level an essential component of received items and incorporating the knowledge that the player has of the game universe and narrative elements.

### BRIEF SUMMARY OF THE INVENTION

The present invention includes a system for incorporating inscriptions into items based on player feats achieved by the performance of specific actions or sequences of actions by the player. The gaming system may include a game server programmed to register an observer that establishes a set of metrics about a feat to be accomplished by a player, to determine whether the player has accomplished a feat according to the set of metrics, and to create an inscription grant for a predetermined game item according to whether the player has accomplished the feat. The gaming system may further include a game client programmed to retrieve the observer registered by the game server, to track the set of metrics during game play by the player, and to report on the set of metrics to the game server. The inscription may be used as a classification of a game item, usually a transferable token such as a weapon, armor, or a valuable object, that defines certain properties of that transferable token based on the action of the player. Inscriptions are granted, updated, or modified according to player actions. The inscription dynamically alters the characteristics of the item according to game play so that player choices on a micro and macro level are an essential component of received items and that the knowledge that the player has of the game universe and narrative elements are incorporated into items collecting during the game.

In one example, the present invention may be a gaming system, comprising a game server programmed to register an observer that establishes a set of metrics about a feat to be accomplished by a player, to determine whether the player has accomplished a feat according to the set of metrics, and to create an inscription grant for a predetermined game item according to whether the player has accomplished the feat and a game client programmed to retrieve the observer registered by the game server, to track the set of metrics during game play by the player, and to report on the set of metrics to the game server. The game server may be programmed to create the inscription grant after a player has accomplished a plurality of stages associated with the feat. The game server may be programmed to determine whether the player has accomplished the feat only after an initiation condition has occurred. The game server may be programmed to determine whether the player has accomplished the feat only based on a completion condition. The feat may comprise a set of mutator descriptions. The game server may be programmed to read in the feat when a player joins game play via the game server. The game server may programmed to read in the observer for the feat when a player joins game play via the game server. The game server may programmed to record actions of the player related to the set of metrics and to provide the recorded actions to the game server.

In another example, the present invention may be a method of providing items based on game player actions when playing a game. In one step, the method involves providing a game server programmed to register an observer that establishes a set of metrics about a feat to be accomplished by a player, to determine whether the player has accomplished a feat according to the set of metrics, and to create an inscription grant for a predetermined game item according to whether the player has accomplished the feat. In another step, the method involves providing a game client programmed to allow the player to join the game. In an additional step, the method involves reading in the feat with the game client when the game player joins the game. In yet a further step, the method involves reading in the observer associated with the feat with the game client. In yet an additional step, the method involves recording actions of the game player directed to the set of metrics with the game client. In yet another step, the method involves reporting the recorded actions from the game client to the game server for determination whether the feat has been accomplished. In yet a further step, the method involves creating an inscription grant if the game server determines that the feat has been accomplished. The game server may create the inscription grant only after a player has accomplished a plurality of stages associated with the feat. The game server may determine whether the player has accomplished the feat only if an initiation condition has occurred. The game server may determine whether the player has accomplished the feat based on a completion condition. The feat may comprise a set of mutator descriptions. The game server may record actions of the player related to the set of metrics and provides the recorded actions to the game server.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a system for inscribing game items according to player accomplishments according to the present invention.

FIG. 2 is a schematic of a process for creating inscriptions from an inscription grant according to the present invention.

FIG. 3 is a schematic of matching of mutators to associated properties according to the present invention.

### DETAILED DESCRIPTION OF THE INVENTION

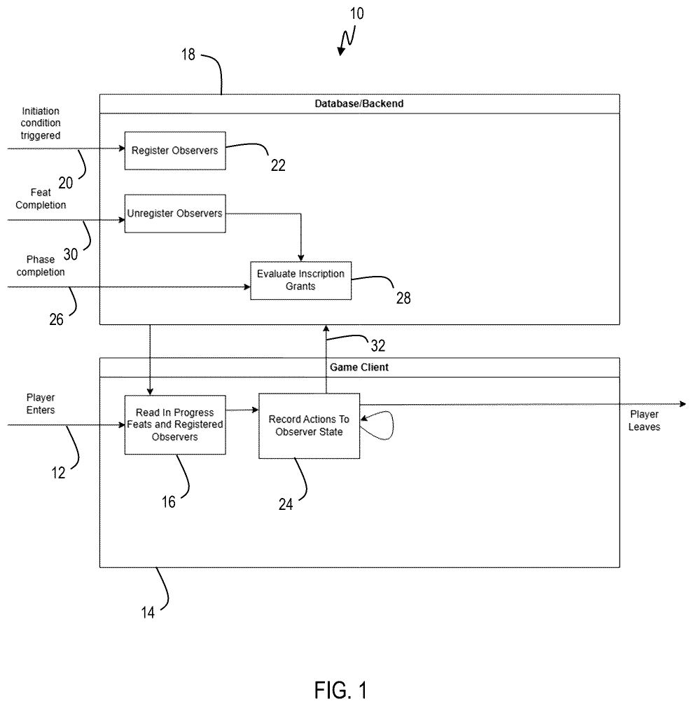

Referring to the figures, wherein like numerals refer to like parts throughout, there is seen in FIG. 1, a schematic of the logical flow of data within a gaming system 10 that uses inscriptions for game items to define item properties according to player actions and, more specifically, the accomplishment of predetermined feats in the game. The term “inscription” is used to refer to the classification of item, which could be a sword, an armor, a gem, including an item which is slotted into another item. Items may be granted the typical properties of RPG items, such as bonus strength or damage. System 10 may further incorporate less typical and even unique effects, which can modify or enhance fundamental mechanics of other aspects of the player character, such as changing a specific single target ability to be a multi target ability or making an ability with no cooldown much more powerful but requiring a cooldown. These capabilities are referred to as inscriptions herein because they record, or inscribe, the actions of the player onto a transferable token such as a predetermined game item.

A core aspect of system 10 is the use of feats. Inscriptions are granted by the performing of specific actions or sequences of actions-which are referred to as feats herein. Feats are an analog of quests or achievements, but have much greater expressive power and allow system 10 to describe an inscription for an item and to provide a method of generating an inscription for an item according to player game play. System 10 thus provides functionality that is generally familiar to players in other contexts, but provides additional functionality beyond that available in conventional systems. System 10 may be provided an add-on to a traditional RPG item system, may replace an RPG item system entirely, or may be even used in genres other than RPG where the game itemization system supports players or player characters holding “items” which grant the player with additional capabilities. While system 10, as more fully described below, reflects a totally deterministic method for generating item rewards, this is not an essential feature and system 10 can easily support randomization of various item properties when they are granted as is done in traditional RPG itemization systems.

Another core aspect of the system is that the metrics and observation logic for determining feats and generating or modifying inscription may be hidden from the player. A player must perform a feat, observe the outputs over many runs, or understand lore/narrative, to predict how the actions affect the final inscription outcome. Various concepts within the system can be assigned human readable metadata which reveals as much or as little information about concept as required by the designer. For example, a designer may introduce a concept of ‘purifying cursed relics’ without describing the in-game actions required to “purify” an item. The facts about that method (where and when and how it must be done) may be revealed either through trial and error or by narrative that is developed within the game.

As described above, feats are a core concept of system 10 and are described by an initiation condition, which is the requirement to start tracking the feat. Some feats may be tracked passively at all times. Feats are also described by a completion condition, which causes the feat to progress to completion with either a grating of the reward or a denial. Feats are further described by stages as well as a completion condition for each stage. These could be sub-objectives or side quests within a feat that are necessary to complete the feat. Feats are additionally described by the set of metrics that will be observed between the initiation of a particular feat and its completion, and how each metric observation is triggered (a metric observer). Feats may also be described by a set of mutator descriptions, which override the global values for each such mutator. Finally, a feat may be described by at least one inscription grants.

An inscription grant is the potential reward for completion of a feat and describes a single inscription which may or may not be granted upon completion of the feat, as well as all potential properties that the inscription may have. The core effect is a collection of stat grants, to which it is possible to able to assign a simple numeric value in the context of a feat. For every stat, the stat grant includes: a range value mapping describing possible output values for that stat; a default input value; and an optional minimum value that, when the output value is below this value, the stat grant is discarded and not applied to the final item. Finally, the inscription grant may include the feat stage whose completion triggers the granting of the inscription grant.

A metric observer describes how a feat records data points in a specific metric (called simply an ‘observer’ herein). Observers are described by the metric to observe, the method to aggregate data points, which may be min/max/sum, etc., the triggering time span, (which may be the duration of the entire feat, at specific points in time during the feat, or at the completion of a specific sub-objective of the feat).

Range value mapping is used to describe and maps input ranges to output ranges (minimum, maximum, exponent).

Range value mapping predicate: in addition to a range value mapping, a least and greatest value, such that the predicate is true when the mapped value is between the least and greatest values.

A mutator description includes a default input value (a number), a set of metrics, which are taken as inputs to the mutator, and for each metric, range value mappings (whose predicates must be satisfied for the mutator to be active) as well as the set of meta tags that are affected by this mutator, and for each meta tag, a multiplier on the mutator output, called the strength value.

Various configuration properties may be used where each are described by a globally unique ID, which may, for example, be a string or a GUID. For example, metrics may be used that represent the actions of players or states of the world. These are game-specific facts about player actions, which include but are not limited to: player actions, map properties, global world properties, and statistics regarding monitored activity such as feat A has been completed X times. Stats atomic properties of items, and each stat has a corresponding set of meta tag. Meta tags, mutators, and feat stages are also established.

System 10 initiates its logic by feats registering their metric observers corresponding to their initiation condition. Whenever a player joins a game 12, the game client 14 consults the global table of feats 16, and for every feat, registers an event observer for metrics within the feats' initiation condition. When recording corresponding actions, the backend 18 will distinguish metrics which are applied to a specific in progress feat, or those which are applied to potentially initiate any new feat. Note that some metric data points will apply to more than one feat, or to an in-progress feat, as well as a potential new feat.

The logical flow of data within system 10 may be seen in FIG. 1. The game client 14 in this example generically refers to any machine which directly or indirectly interacts with player input in order to create the player experience. This could be a game executable running on the players' machine, it could be a game server running on any machine to which the player connects over the internet, or it could be a web browser. Game client 14 needs to only simulate some part of the game universe, typically the ‘area’ or ‘level’ in which the player character currently resides.

Persistent observers are an important aspect of system 10. Once a feat is initiated 20, it may continue for a long time, or even forever. In other words, the lifetime of a feat spans across many game instances. This requires that metrics observers are registered 22 so that they can be tracked across playthroughs, so a machine-independent representation of observers is kept in the game backend 18. Whenever a player joins a game 12, game client 14 reads all of the in-progress feats 16 and registered observers of the player character, and listens to events within its local game simulation that correspond to those types of observed metrics 24. For example, if one observed metric is ‘fire damage dealt’ then the game client needs to simulate the corresponding processes for ‘dealing damage.’ This approach also requires that various components of the system are global properties, so that they have fixed values at any given time. Feat descriptions and mutators have a global description. Whenever the client needs to know facts about a feat or mutator, it consults a local copy of the global properties. While the global properties might be very large, game clients can cache a copy locally.

Inscription creation is another aspect of system 10. Completing a phase of a feat 26 may trigger an inscription grant 28. This process is independent for every grant in the feat description. Feat completion 30 is always based on metrics which form part of the observed metrics 24 within the feat. Game client 14, which records relevant actions for observed metrics 24, is therefore always aware of potential feat advancement. Whenever game client 14 records an action 24 and communicates 32 with the backend 18, part of the result returned by back end 18 is which feat stages, if any, were completed.

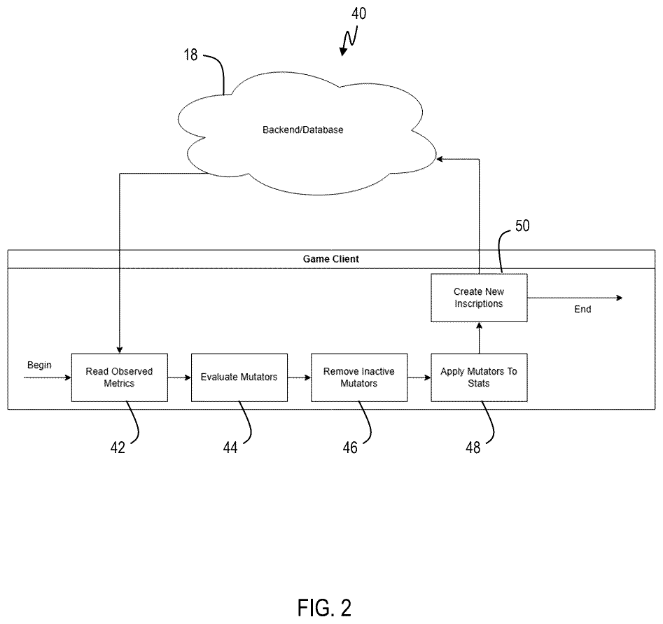

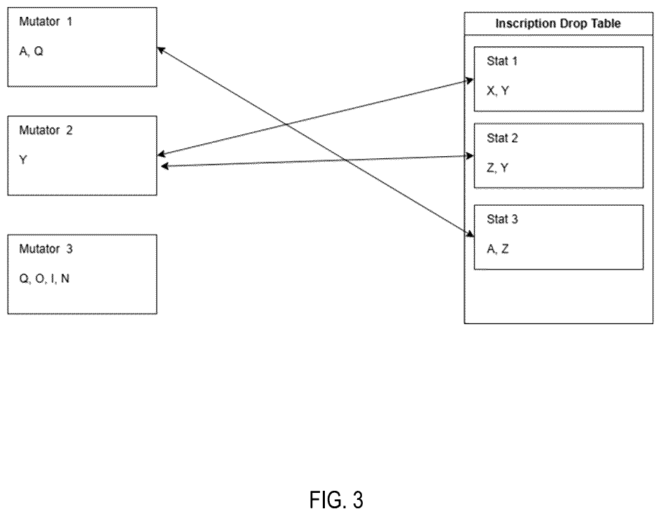

Referring to FIG. 2, system 10 includes a process for creating a concrete inscription 40 from an inscription grant 28. Once a feat or stage is known to be completed, inscription creation 40 can proceed. This occurs within the context of the feat being progressed, so game client 14 is aware of the inscription grant being created. In a first step, the client evaluates fetches the values of observed metric values 42 from backend 18. In a next step, the client evaluates mutators 44. Mutators can be applied either to stat values, or to other mutator values. Mutators are applied to stats on the granted item. For example, mutators are matched to each stat which is available on the granted item, and to each other mutator being evaluated. A mutator matches a stat or mutator if its meta tags have any overlap with the meta tags of the stat or mutator. Local feat descriptions can override the global properties of mutators. For every mutator, to find its description, first check if the feat has an override, and if not, use the global properties. Mutators may affect other mutators-topologically sort the set of mutators by the relationship ‘is affected by’ and further evaluation proceeds in topological sort order. For each mutator, to determine its final output, evaluate each mutator in the context of the fetched metric values. Then, apply any matching preceding mutators to the currently evaluating mutator. Mutators whose predicate is not satisfied are then removed 46. For every stat in the inscription grant, apply matching mutators to the stat 48, which produces the final output value 50. Matching of the mutators to the affected properties is seen in FIG. 3. For every stat, if it has an optional minimum value, remove that stat if its final output is less than that minimum.

Once a mutator ‘A’ is evaluated (its final output is known), then applying a mutator to a stat or mutator ‘B’ proceeds as follows. For every matching meta tag, multiply the mutator ‘A’ final output by the strength multiplier for that meta tag. Add the multiplied values for every meta tag to the input value of the stat or mutator ‘B’ (which is initially the default input value).

System 10 further comprises content cycle subsystem where global mutator properties and local feat mutator overrides can vary over time. This allows content to be hand crafted by designers. Typical live service games have content cycles lasting 3-6 months, in which there is a new mechanic introduced.

Global mutator properties and available feats may be stored in a database accessible to the game client. While the database is potentially large, updates to the database are infrequent and happen at regular intervals. In other words, global mutator and feat state contains the time of the next update as part of its metadata.

What is claimed is:

1. A gaming system, comprising:
a game server programmed to register an observer that establishes a set of metrics about a feat to be accomplished by a player, to determine whether the player has accomplished a feat according to the set of metrics, and to create an inscription grant for a predetermined game item according to whether the player has accomplished the feat; and
a game client programmed to retrieve the observer registered by the game server, to track the set of metrics during game play by the player, and to report on the set of metrics to the game server.

2. The gaming system of claim 1, wherein the game server is programmed to create the inscription grant after the player has accomplished a plurality of stages associated with the feat.

3. The gaming system of claim 2, wherein the game server is programmed to determine whether the player has accomplished the feat only after an initiation condition has occurred.

4. The gaming system of claim 3, wherein the game server is programmed to determine whether the player has accomplished the feat only based on a completion condition.

5. The gaming system of claim 1, wherein the feat comprises a set of mutator descriptions.

6. The gaming system of claim 1, wherein the game server is programmed to read in the feat when a player joins game play via the game client.

7. The gaming system of claim 6, wherein the game server is programmed to read in the observer for the feat when a player joins game play via the game server.

8. The gaming system of claim 7, wherein the game server is programmed to record actions of the player related to the set of metrics and to provide the recorded actions to the game server.

9. A method of providing items based on actions of a player in a game, comprising the steps of:
providing a game server programmed to register an observer that establishes a set of metrics about a feat to be accomplished by a player, to determine whether the player has accomplished a feat according to the set of metrics, and to create an inscription grant for a predetermined game item according to whether the player has accomplished the feat;
providing a game client programmed to allow the player to join the game;
reading in the feat with the game client when the player joins the game;
reading in the observer associated with the feat with the game client;
recording actions of the player directed to the set of metrics with the game client;
reporting the recorded actions from the game client to the game server for determination whether the feat has been accomplished; and
creating an inscription grant if the game server determines that the feat has been accomplished.

10. The method of claim 9, wherein the game server creates the inscription grant only after a player has accomplished a plurality of stages associated with the feat.

11. The method of claim 9, wherein the game server determines whether the player has accomplished the feat only if an initiation condition has occurred.

12. The method of claim 9, wherein the game server determines whether the player has accomplished the feat based on a completion condition.

13. The method of claim 9, wherein the feat comprises a set of mutator descriptions.

14. The method of claim 9, wherein the game server records actions of the player related to the set of metrics and provides the recorded actions to the game server.
